(19) United States
(12) Patent Application Publication
(10) Pub. No.: US 2026/0118920 A1
(43) Pub. Date: Apr. 30, 2026

(54) DISPLAY PANEL, WIRELESS COMMUNICATION APPARATUS, AND MULTI-FUNCTION ASSEMBLY

(71) Applicant: Yungu (Gu’an) Technology Co., Ltd., Langfang, Hebei (CN)

(72) Inventors: Huan-Chu HUANG, Taoyuan (CN); Shuang CUI, Langfang (CN); Jie WU, Langfang (CN)

(73) Assignee: Yungu (Gu’an) Technology Co., Ltd., Langfang, Hebei (CN)

(21) Appl. No.: 19/417,733

(22) Filed: Dec. 12, 2025

Related U.S. Application Data
(63) Continuation of application No. PCT/CN2023/134226, filed on Nov. 27, 2023.

(30) Foreign Application Priority Data
Jun. 13, 2023 (CN) 202310699602.X

(51) Int. Cl. G06F 1/16; H01Q 1/22; H01Q 1/52; H01Q 21/30

(52) U.S. Cl. CPC G06F 1/1698; H01Q 1/22; H01Q 1/52; H01Q 21/30

(57) ABSTRACT

A display panel, a wireless communication apparatus, and a multi-function assembly. The display panel includes: a base plate; a functional layer arranged on the base plate and including one or more multi-function units for reflecting wireless signals; a blocking layer arranged at a side of the multi-function units facing the base plate; and an antenna assembly including a non-millimeter wave antenna unit and a millimeter wave antenna unit, the multi-function units being reused as the millimeter wave antenna unit and a portion of the non-millimeter wave antenna unit.

### CROSS REFERENCE TO RELATED APPLICATION

The present application is a continuation application of International Application No. PCT/CN2023/134226, filed on Nov. 27, 2023, which claims priority to Chinese Patent Application No. 202310699602.X filed on Jun. 13, 2023, both of which are incorporated herein by reference in their entireties.

### FIELD

The present application relates to the field of display apparatus, and particularly to a display panel, a wireless communication apparatus, and a multi-function assembly.

### BACKGROUND

The functions of the wireless communication apparatus (e.g., a cellular phone, a smart watch, etc.) are changing rapidly, and the market demand for the appearance and wireless communication performance of the apparatus is also increasing. How to improve the wireless communication performance of the wireless communication apparatus has become an urgent technical problem to be solved.

### SUMMARY

Embodiments of the present application provide a display panel, a wireless communication apparatus, and a multi-function assembly, aiming to improve the wireless communication performance of the display panel.

Some embodiments of a first aspect of the present application provide a display panel, including: a base plate; a functional layer arranged on the base plate and including one or more multi-function units for reflecting wireless signals; a blocking layer arranged at a side of the multi-function units facing the base plate; and an antenna assembly including a non-millimeter wave antenna unit and a millimeter wave antenna unit, the multi-function units being reused as the millimeter wave antenna unit and a portion of the non-millimeter wave antenna unit.

Some embodiments of a second aspect of the present application provide a wireless communication apparatus, including the display panel of any of the above embodiments of the first aspect.

Some embodiments of a third aspect of the present application provide a multi-function assembly, including: a functional layer including one or more multi-function units for reflecting wireless signals; a blocking layer arranged at a side of the functional layer; and an antenna assembly including a non-millimeter wave antenna unit and a millimeter wave antenna unit, the multi-function units being reused as the millimeter wave antenna unit and a portion of the non-millimeter wave antenna unit.

In the display panel according to the embodiments of the present application, the display panel includes a base plate, a functional layer, a blocking layer, and an antenna assembly, in which the functional layer includes multi-function units which are capable of reflecting wireless signals, thereby improving the wireless performance of the display panel; the blocking layer is arranged at a side of the functional layer away from a display surface of the display panel and used to block wireless signals incident from the display surface. The antenna assembly includes a millimeter wave antenna unit and a non-millimeter wave antenna unit, so that the display panel can transmit millimeter wave antenna signals and non-millimeter wave antenna signals, which can further enrich the wireless communication function of the display panel. In addition, the multi-function units are reused as the millimeter wave antenna unit and a portion of the non-millimeter wave antenna unit, and thus the structure of the display panel can be simplified.

### BRIEF DESCRIPTION OF THE DRAWINGS

FIG. 1 shows a schematic structural diagram of a display panel according to an embodiment of the first aspect of the present application;

FIG. 2 shows a sectional view at A-A in FIG. 1;

FIG. 3 shows a sectional view at B-B in FIG. 1;

FIG. 4 shows a schematic structural diagram of a display panel according to another embodiment of the first aspect of the present application;

FIG. 5 shows a schematic structural diagram of a display panel according to yet another embodiment of the first aspect of the present application;

FIG. 6 shows a schematic structural diagram of a display panel according to yet another embodiment of the first aspect of the present application;

FIG. 7 shows a sectional view at C-C in FIG. 6;

FIG. 8 shows a schematic structural diagram of a circuit of a display panel according to an embodiment of the first aspect of the present application;

FIG. 9 shows a schematic structural diagram of a display panel according to yet another embodiment of the first aspect of the present application;

FIG. 10 shows a schematic structural diagram of a circuit of a display panel according to another embodiment of the first aspect of the present application;

FIG. 11 shows a schematic structural diagram of a display panel according to yet another embodiment of the first aspect of the present application;

FIG. 12 shows a schematic structural diagram of a display panel according to yet another embodiment of the first aspect of the present application;

FIG. 13 shows a schematic structural diagram of a circuit of a display panel according to yet another embodiment of the first aspect of the present application;

FIG. 14 shows a schematic structural diagram of a display panel according to yet another embodiment of the first aspect of the present application;

FIG. 15 shows a schematic structural diagram of a display panel according to yet another embodiment of the first aspect of the present application;

FIG. 16 shows a schematic structural diagram of a display panel according to yet another embodiment of the first aspect of the present application;

FIG. 17 shows a schematic structural diagram of a display panel according to yet another embodiment of the first aspect of the present application;

FIG. 18 shows a schematic structural diagram of a display panel according to yet another embodiment of the first aspect of the present application;

FIG. 19 shows a schematic structural diagram of a display panel according to yet another embodiment of the first aspect of the present application;

FIG. 20 shows a schematic structural diagram of a circuit of a display panel according to yet another embodiment of the first aspect of the present application;

FIG. 21 shows a partial sectional view of a display panel according to an embodiment of the first aspect of the present application;

FIG. 22 shows a partial sectional view of a display panel according to another embodiment of the first aspect of the present application;

FIG. 23 shows a schematic structural diagram of a display panel according to yet another embodiment of the first aspect of the present application;

FIG. 24 shows a schematic structural diagram of a display panel according to yet another embodiment of the first aspect of the present application;

FIG. 25 shows a schematic structural diagram of a display panel according to yet another embodiment of the first aspect of the present application;

FIG. 26 shows a schematic structural diagram of a display panel according to yet another embodiment of the first aspect of the present application;

FIG. 27 shows a schematic structural diagram of a wireless communication apparatus according to an embodiment of the second aspect of the present application;

FIG. 28 shows a schematic structural diagram of a wireless communication apparatus according to another embodiment of the second aspect of the present application;

FIG. 29 shows a schematic structural diagram of a circuit board, in an unfolded state, of a wireless communication apparatus according to an embodiment of the second aspect of the present application;

FIG. 30 shows a schematic structural diagram of a circuit board, in a folded state, of a wireless communication apparatus according to an embodiment of the second aspect of the present application;

FIG. 31 shows a schematic structural diagram of a wireless communication apparatus according to yet another embodiment of the second aspect of the present application.

### DETAILED DESCRIPTION

With the development of display technology and wireless communication technology, the demand for the communication performance of the wireless communication apparatus is becoming higher and higher. Intelligent Reflecting Surface (IRS) is an important communication design that has gained a lot of attention and been extensively studied nowadays, the IRS can change the direction and number of the reflected beams incident from a wireless signal source by regulating the amplitude and phase of the electrical signals on a plurality of reflecting units on the surface (i.e., by changing the electrical loads of the reflecting units), and thus can maintain the reflected beams as one reflected beam or divide the reflected beams into a plurality of reflected beams, so as to regulate the direction to focus on one or more communication targets, therefore the wireless communication quality can be significantly improved. The IRS may be disposed on the interior or exterior walls of the building. In addition, the antenna is also an important functional component for transmitting wireless signals in the wireless communication apparatus.

The IRS is generally composed of a three-layer structure, in which the surface layer is a reflecting unit, which is a conductor structure and used to reflect wireless signals. A metal plate such as a copper plate is under the reflecting unit and used to block and reflect the wireless signals. A control circuit board is arranged at a side of the metal plate away from the reflecting unit, and the control circuit on the control circuit board is connected with the reflecting unit and used to regulate the signal amplitude and phase of each reflecting unit, so as to control the direction and number of the reflected beams. Nonetheless, this three-layer structure is not transparent for human eyes, and thus the IRS is not transparent for human eyes, either.

In order to improve the communication performance of the wireless communication apparatus, the present application integrates the IRS onto the wireless communication apparatus and reuses the reflecting unit in the IRS and the antenna unit in the antenna, so as to improve the wireless communication performance of the wireless communication apparatus.

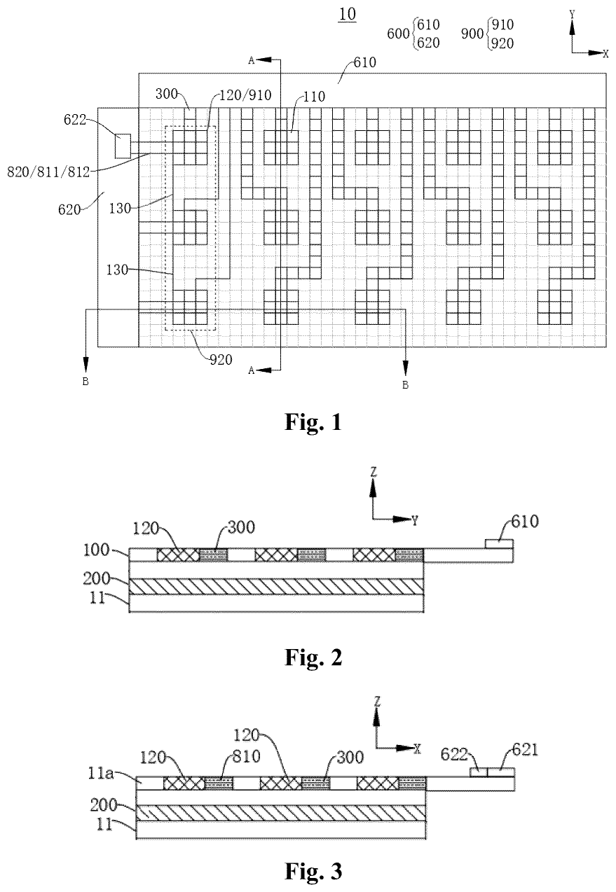

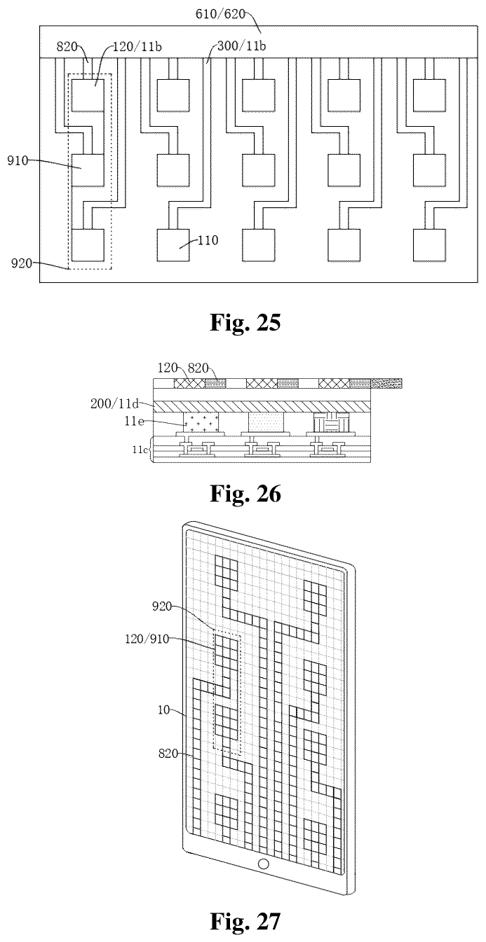

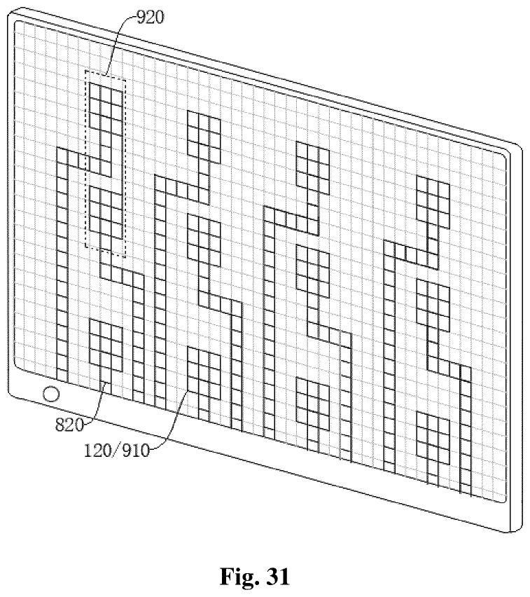

The present application is proposed to solve the above problems. In order to better understand the present application, the display panel, the wireless communication apparatus, and the multi-function assembly according to the embodiments of the present application are described in detail below in conjunction with FIGS. 1 to 31.

Reference is made to FIGS. 1 to 3 together, in which FIG. 1 shows a schematic structural diagram of a display panel 10 according to an embodiment of the present application, FIG. 2 shows a sectional view at A-A in FIG. 1, and FIG. 3 shows a sectional view at B-B in FIG. 1.

As shown in FIGS. 1 to 3, the display panel 10 includes a base plate 11, a functional layer 100, a blocking layer 200, and an antenna assembly 900. The functional layer 100 is arranged on the base plate 11 and includes one or more multi-function units 120 for reflecting wireless signals; the blocking layer 200 is arranged at a side of the multi-function units 120 facing the base plate 11; and the antenna assembly 900 includes a non-millimeter wave antenna unit 920 and a millimeter wave antenna unit 910, the multi-function units 120 are reused as the millimeter wave antenna unit 910 and a portion of the non-millimeter wave antenna unit 920. The location of the non-millimeter wave antenna unit 920 is illustrated in FIG. 1 by a dashed box, which does not limit the structure of the display panel 10 of the embodiments of the present application.

In the display panel 10 according to the embodiments of the present application, the display panel 10 includes a base plate 11, a functional layer 100, a blocking layer 200, and an antenna assembly 900, in which the functional layer 100 includes multi-function units 120 which are capable of reflecting wireless signals, thereby improving the wireless performance of the display panel 10; the blocking layer 200 is arranged at a side of the functional layer 100 away from a display surface of the display panel 10 and used to block wireless signals incident from the display surface. The antenna assembly 900 includes a millimeter wave antenna unit 910 and a non-millimeter wave antenna unit 920, so that the display panel 10 can transmit millimeter wave antenna signals and non-millimeter wave antenna signals, which can further enrich the wireless communication function of the display panel 10. In addition, the multi-function units 120 are reused as the millimeter wave antenna unit 910 and a portion of the non-millimeter wave antenna unit 920, and thus the structure of the display panel 10 can be simplified.

In some embodiments, the blocking layer 200 may be used as the above metal plate in the IRS to block and reflect wireless signals.

The multi-function unit 120 being reused as the millimeter wave antenna unit 910 and a portion of the non-millimeter wave antenna unit 920 means that: the multi-function unit 120 is reused as the millimeter wave antenna unit 910, and the multi-function unit 120 is also reused as a portion of the non-millimeter wave antenna unit 920.

In some embodiments, the multi-function unit 120 is reused as the millimeter wave antenna unit 910 and can be further used to transmit millimeter wave antenna signals.

In some embodiments, the multi-function unit 120 being reused as a portion of the non-millimeter wave antenna unit 920 may mean that: one multi-function unit 120 is reused as a portion of the non-millimeter wave antenna unit 920; or at least two adjacent multi-function units 120 are connected through a connecting signal line 130 and reused as a portion of the non-millimeter wave antenna unit 920; or at least two adjacent multi-function units 120 are connected through a connecting signal line 130 and reused as the non-millimeter wave antenna unit 920. The multi-function unit 120 being reused as a portion of the non-millimeter wave antenna unit 920 means that the multi-function unit 120 may have the functionality of the non-millimeter wave antenna unit 920 and be used to transmit and receive non-millimeter wave wireless signals.

In some embodiments, if at least two adjacent multi-function units 120 are connected through a connecting signal line 130 and reused as a portion of the non-millimeter wave antenna unit 920, the at least two adjacent multi-function units 120 are connected in series and/or in parallel with each other through the connecting signal line 130 and reused as a portion of the non-millimeter wave antenna unit 920.

In some embodiments, the multi-function unit 120 reused as the millimeter wave antenna unit 910 and the multi-function unit 120 reused as a portion of the non-millimeter wave antenna unit 920 may be the same multi-function unit 120 or different multi-function units 120.

In some embodiments, the millimeter wave antenna unit 910 is a radiating portion of a millimeter wave antenna, or the millimeter wave antenna unit 910 includes a millimeter wave feeding portion and a millimeter wave radiating portion, and the multi-function unit 120 may be reused as the millimeter wave radiating portion. Optionally, the non-millimeter wave antenna unit 920 is a radiating portion of a non-millimeter wave antenna, or the non-millimeter wave antenna unit 920 includes a non-millimeter wave feeding portion and a non-millimeter wave radiating portion, and the multi-function unit 120 may be reused as a portion of the non-millimeter wave radiating portion.

In some embodiments, if the display panel 10 is used in a wireless communication apparatus including a control assembly 600 with a control circuit 610 and a radio frequency circuit 620, the multi-function unit 120 and the control circuit 610 are electrically connected with each other, so that the control circuit 610 varies the electrical load of the multi-function unit 120. The radio frequency circuit 620 includes a millimeter wave radio frequency circuit 621 and a non-millimeter wave radio frequency circuit 622, the millimeter wave radio frequency circuit 621 is connected to at least one multi-function unit 120 so that the multi-function unit 120 is reused as the millimeter wave antenna unit 910 and used to transmit millimeter wave antenna signals, and the non-millimeter wave radio frequency circuit 622 is connected to at least one multi-function unit 120 so that the multi-function unit 120 is reused as a portion of the non-millimeter wave antenna unit 920 and used to transmit non-millimeter wave antenna signals. Optionally, the control assembly 600 may be disposed in the display panel 10, i.e., the display panel 10 includes the control assembly 600 as described above.

In some embodiments, a same one of the multi-function units 120 is reused as the millimeter wave antenna unit 910 and a portion of the non-millimeter wave antenna unit 920, that is, the same multi-function unit 120 can be used to transmit both millimeter wave antenna signals and non-millimeter wave antenna signals, which can further simplify the structure of the display panel 10.

In other embodiments, at least one of a plurality of multi-function units 120 is reused as the millimeter wave antenna unit 910, and at least another one of the multi-function units 120 is reused as a portion of the non-millimeter wave antenna unit 920. That is, the multi-function unit 120 reused as the millimeter wave antenna unit 910 and the multi-function unit 120 reused as a portion of the non-millimeter wave antenna unit 920 are different multi-function units 120, which can reduce signal crosstalk.

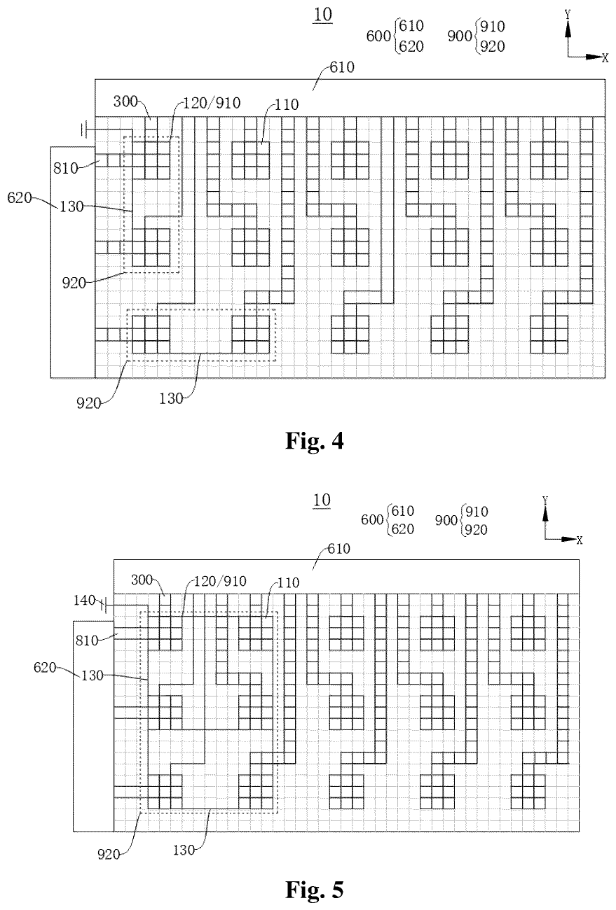

In some embodiments, as shown in FIG. 4, the number of the non-millimeter wave antenna units 920 and/or the number of the millimeter wave antenna units 910 may be two or more, so as to improve the ability of the display panel 10 to transmit non-millimeter wave signals and/or millimeter wave signals. Alternatively, as shown in FIGS. 1 and 5, the number of the non-millimeter wave antenna units 920 may be one. FIG. 5 differs from FIG. 1 in that the non-millimeter wave antenna unit 920 includes a different number of multi-function units 120.

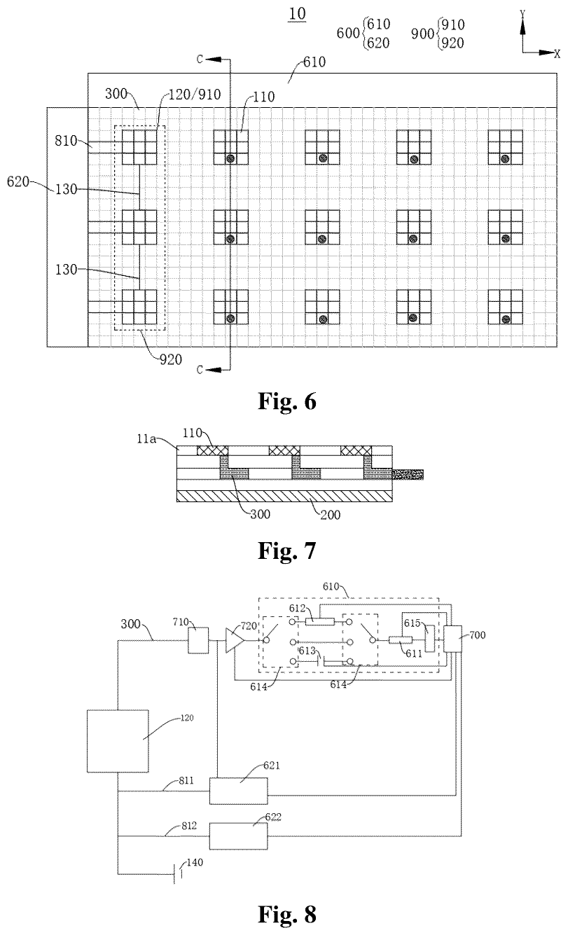

In some embodiments, the display panel 10 includes a control line 300 and the multi-function units 120, and the control line 300 connects the control circuit 610 and the multi-function units 120. As shown in FIGS. 1 to 3, the control line 300 and the multi-function unit 120 may be arranged in a same layer, or alternatively, as shown in FIGS. 6 and 7, the control line 300 and the multi-function unit 120 may be arranged in different layers. In FIGS. 6 and 7, the multi-function unit 120 and the reflecting unit 110 are arranged in a same layer, therefore if the control line 300 and the multi-function unit 120 are arranged in different layers, as shown in FIG. 7, the control line 300 and the reflecting unit 110 are arranged in different layers.

As shown in FIGS. 6 to 8, the same multi-function unit 120 is connected with the control circuit 610 as well as the millimeter wave radio frequency circuit 621 and the non-millimeter wave radio frequency circuit 622, so that the same multi-function unit 120 can be reused as a reflecting surface, the millimeter wave antenna unit 910, and a portion of the non-millimeter wave antenna unit 920.

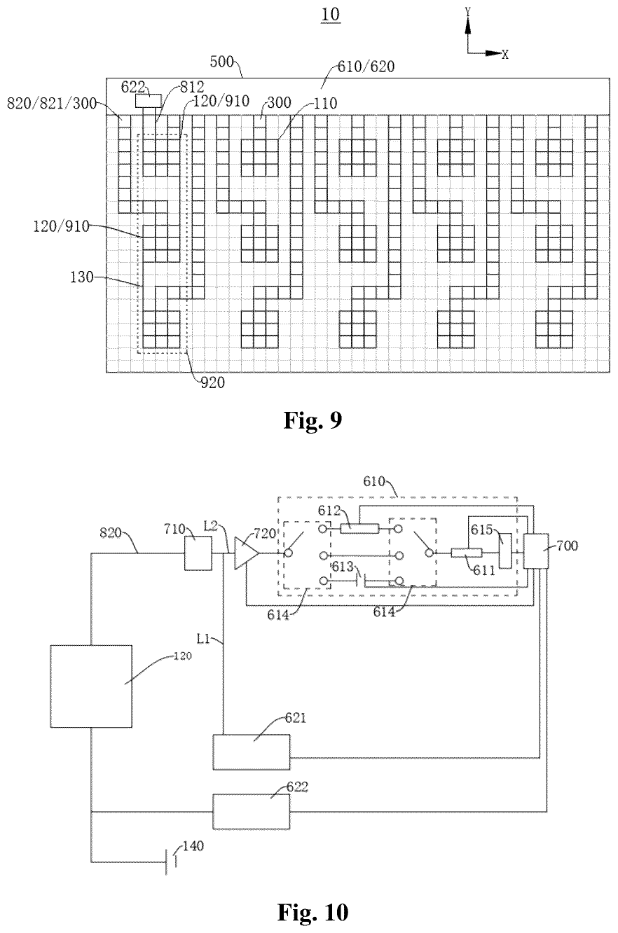

In some embodiments, as shown in FIG. 9, the display panel 10 further includes a multi-function control feeder line 820, in which one end of the multi-function control feeder line 820 is connected to the multi-function unit 120, and the other end of the multi-function control feeder line 820 is configured to be connected to the control circuit 610 and the radio frequency circuit 620, so as to enable the control circuit 610 and the radio frequency circuit 620 to transmit a control signal to the multi-function unit 120 via the multi-function control feeder line 820.

In these embodiments, the multi-function control feeder line 820 can connect the control circuit 610 to the multi-function unit 120, and further connect the radio frequency circuit 620 to the multi-function unit 120, which can further simplify the structure of the display panel 10.

If the multi-function unit 120 is reused as the millimeter wave antenna unit 910, the other end of the multi-function control feeder line 820 is connected to the millimeter wave radio frequency circuit 621. If the multi-function unit 120 is reused as the non-millimeter wave antenna unit 920, the other end of the multi-function control feeder line 820 is connected to the non-millimeter wave radio frequency circuit 622. If the same multi-function unit 120 is reused the millimeter wave antenna unit 910 and a portion of the non-millimeter wave antenna unit 920, the other end of the multi-function control feeder line 820 is connected to the millimeter wave radio frequency circuit 621 and the non-millimeter wave radio frequency circuit 622.

In some embodiments, as shown in FIGS. 6 to 8, the display panel 10 further includes a radio frequency line 810 for connecting the radio frequency circuit 620 to the multi-function unit 120. The radio frequency line 810 includes a millimeter wave feeder line 811 and a non-millimeter wave feeder line 812. The multi-function control feeder line 820 may be reused as at least two of the millimeter wave feeder line 811, the non-millimeter wave feeder line 812, and the control line 300.

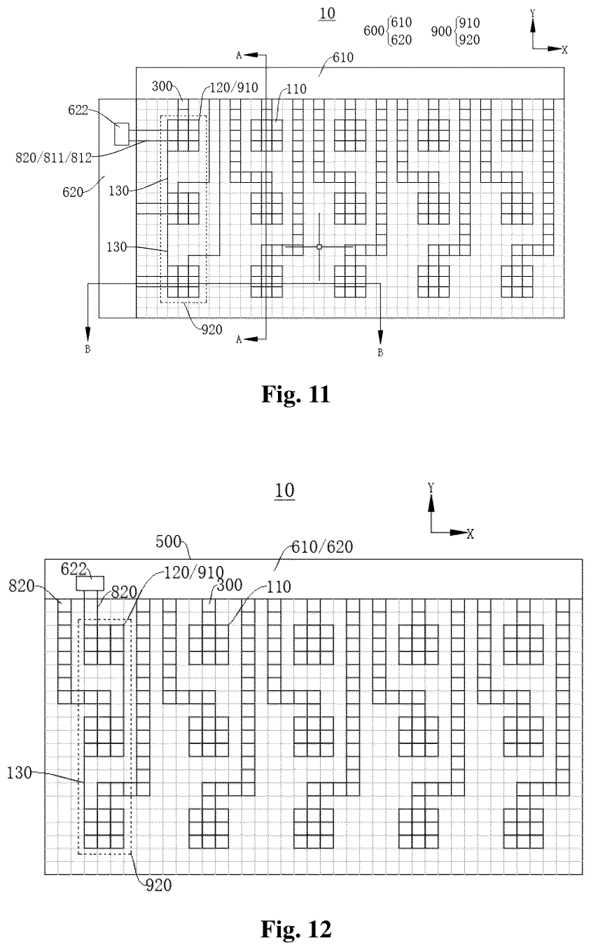

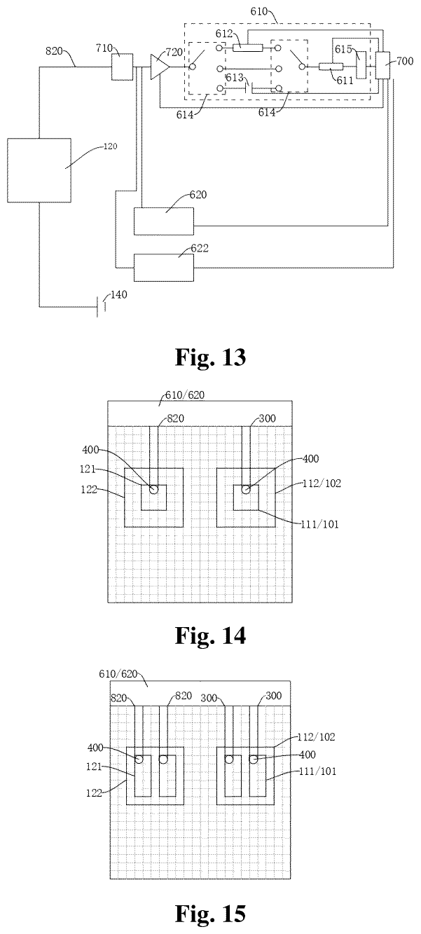

As shown in FIGS. 9 and 10, the multi-function control feeder line 820 is reused as the millimeter wave feeder line 811 and the control line 300, the display panel 10 includes the non-millimeter wave feeder line 812 and the multi-function control feeder line 820, the non-millimeter wave feeder line 812 connects the non-millimeter wave radio frequency circuit 622 to the multi-function unit 120, and the multi-function control feeder line 820 connects the multi-function unit 120 to the millimeter wave radio frequency circuit 621 and the control circuit 610. Alternatively, as shown in FIG. 11, the multi-function control feeder line 820 is reused as the millimeter wave feeder line 811 and the non-millimeter wave feeder line 812, the display panel 10 includes the control line 300 and the multi-function control feeder line 820, the control line 300 connects the control circuit 610 to the multi-function unit 120, and the multi-function control feeder line 820 connects the multi-function unit 120 to the millimeter wave radio frequency circuit 621 and the non-millimeter wave radio frequency circuit 622. Alternatively, as shown in FIGS. 12 and 13, the multi-function control feeder line 820 is reused as the millimeter wave feeder line 811, the non-millimeter wave feeder line 812, and the control line 300. The multi-function control feeder line 820 connects the multi-function unit 120 to the millimeter wave radio frequency circuit 621, the non-millimeter wave radio frequency circuit 622, and the control circuit 610.

In some embodiments, as shown in FIGS. 1 to 13, two or more of the multi-function units 120 are connected to each other by the connecting signal line 130 and reused as the non-millimeter wave antenna unit 920, i.e., the non-millimeter wave antenna unit 920 is formed by reusing two or more multi-function units 120, which can further simplify the structure of the non-millimeter wave antenna unit 920.

In some embodiments, at least one of the two or more multi-function units 120 reused as the non-millimeter wave antenna unit 920 is reused as the millimeter wave antenna unit 910, so as to further simplify the structure of the display panel 10.

In any of the above embodiments, the connecting signal line 130 may be set in various ways. For example, the connecting signal line 130 may include a single wire or a plurality of wires arranged side-by-side, or the connecting signal line 130 may include a plurality of wires arranged side-by-side and a bridge wire for connecting the wires arranged side-by-side.

If the multi-function units 120 that are connected to each other and reused as the non-millimeter wave antenna unit 920 are further reused as the millimeter wave antenna unit 910, at least a portion of the connecting signal line 130 has a line width that is not greater than the width of the millimeter wave antenna unit 910. Optionally, the millimeter wave antenna unit 910 includes a millimeter wave wire, and at least a portion of the connecting signal line 130 has a line width that is not greater than the width of the millimeter wave wire in the millimeter wave antenna unit 910.

If the millimeter wave antenna unit 910 is block-shaped, the millimeter wave antenna unit 910 may be understood to include one millimeter wave wire; and if the millimeter wave antenna unit 910 includes a plurality of millimeter wave wires, at least a portion of the connecting signal line 130 having a line width that is less than the width of the millimeter wave antenna unit 910 means that: the line width of at least a portion of the connecting signal line 130 is less than the sum of the widths of the plurality of millimeter wave wires in the millimeter wave antenna unit 910.

In the embodiments of the present application, if at least a portion of the connecting signal line 130 has a line width that is not greater than the width of the millimeter wave wire in the millimeter wave antenna unit 910, the connecting signal line 130 is narrower and thus has a higher impedance, so that the connecting signal line 130 can better filter and block the currents in millimeter wave band. Nonetheless, the connecting signal line 130 may transit all non-millimeter wave currents. Therefore, in the embodiments of the present application, the non-millimeter wave currents can better pass through the connecting signal line 130, while the millimeter wave currents are blocked by the connecting signal line 130.

The millimeter wave current refers to a current corresponding to the millimeter wave band wireless signal frequency band transmitted and received by the millimeter wave antenna unit 910, and the non-millimeter wave current refers to a current corresponding to the non-millimeter wave wireless signal frequency band transmitted and received by the non-millimeter wave antenna unit 920.

In some embodiments, if at least a portion of the connecting signal line 130 has a line width that is not greater than the width of the millimeter wave antenna unit 910, as shown in FIG. 1, and if the connecting signal line 130 includes a single wire, the line width of the single wire in the connecting signal line 130 is not greater than the sum of the line widths of the millimeter wave wires in the millimeter wave antenna unit 910 extending in the same direction as the connecting signal line 130. In other embodiments, if the connecting signal line 130 includes a plurality of wires, the sum of the line widths of the plurality of wires in the connecting signal line 130 is not greater than the sum of the line widths of the millimeter wave wires in the millimeter wave antenna unit 910 extending in the same direction as the connecting signal line 130. As shown in FIG. 1, if the first direction X is perpendicular to the second direction Y and the connecting signal line 130 extends along the second direction Y, the line width direction of the connecting signal line 130 is the first direction X, and the width direction of the millimeter wave wire is also the first direction X.

In the embodiment of the present application, if the sum of the line widths of the wires in the connecting signal line 130 is not greater than the sum of the line widths of the millimeter wave wires in the millimeter wave antenna unit 910 extending in the same direction as the connecting signal line 130, the connecting signal line 130 is narrower and thus has a higher impedance, so that the connecting signal line 130 can better filter and block the currents in millimeter wave band.

The connecting signal line 130 may be set in various ways. For example, the connecting signal line 130 may be a straight line, i.e., the connecting signal line 130 extends in a same direction. Alternatively, the connecting signal line 130 may be a bent line, i.e., the connecting signal line 130 extends along a bent path. Alternatively, the connecting signal line 130 may be an arc line. Alternatively, the connecting signal line 130 is formed by a combination of at least two of the straight line, the folded line, and the arc line.

In some embodiments, as shown in FIGS. 9 and 13, at least one non-millimeter wave antenna unit 920 is connected to a first signal voltage 140, which may be a negative voltage signal or a ground voltage signal.

In some embodiments, the non-millimeter wave antenna unit 920 may be connected to the first signal voltage 140 via a reused multi-function unit 120, i.e., at least one of the multi-function units 120 reused as the non-millimeter wave antenna unit 920 is connected to the first signal voltage 140, or the non-millimeter wave antenna unit 920 may be connected to the first signal voltage 140 via the connecting signal line 130.

In some embodiments, if the number of the non-millimeter wave antenna units 920 is two or more, it is sufficient that at least one of the non-millimeter wave antenna units 920 is connected to the first signal voltage 140.

In some embodiments, in any of the above embodiments, the millimeter wave antenna unit 910 is used to transmit/receive millimeter wave band wireless signals, i.e., to transmit and/or receive millimeter wave band wireless signals. Similarly, the non-millimeter wave antenna unit 920 is used to transmit/receive non-millimeter wave band wireless signals, i.e., to transmit and/or receive non-millimeter wave band wireless signals.

Two or more millimeter wave antenna units 910 are distributed at intervals around the periphery of the display panel 10, and the millimeter wave antenna units 910 are located at different locations on the display panel 10. When a user operates the display panel 10 using different gestures, there can always be one or more millimeter wave antenna units 910 that are not blocked by the user, so that the stability of the millimeter wave antenna units 910 for receiving and transmitting wireless signals can be increased, and the wireless experience of the user can be improved.

In some embodiments, the non-millimeter wave antenna units 920 are distributed at intervals around the periphery of the display panel 10, and the non-millimeter wave antenna units 920 are located at different locations on the display panel 10. When a user operates the display panel 10 using different gestures, there can always be one or more non-millimeter wave antenna units 920 that are not blocked by the user, so that the stability of the non-millimeter wave antenna units 920 for receiving and transmitting wireless signals can be increased, and the wireless experience of the user can be improved.

In any of the above embodiments, optionally, the multi-function units 120 are located in a display area of the display panel 10, and the light transmittance of the multi-function units 120 and the blocking layer 200 is greater than or equal to 50%, so as to reduce the effect of the multi-function units 120 on the display of the display panel 10. In some other embodiments, if the multi-function units 120 are located in a non-display area of the display panel 10, the light transmittance of the multi-function units 120 is not limited.

The display surface of the display panel 10 is the light-emitting surface of the display panel 10, and the functional layer 100 is arranged closer to the light-emitting surface of the display panel 10 than the blocking layer 200. When wireless signals are incident via the light-emitting surface of the display panel 10, the wireless signals will be first incident to the functional layer 100 and reflected by the multi-function units 120 of the functional layer 100. A portion of the wireless signals will be incident to the blocking layer 200 through gaps between adjacent multi-function units and blocked by the blocked layer 200.

In some embodiments, each of the multi-function units 120 is connected to at least one control circuit 610, and different multi-function units 120 are connected to different control circuits 610, so that the multi-function units 120 are separately controlled through the control circuits 610. Optionally, each of the multi-function units 120 is connected to at least one radio frequency circuit 620, and for example, each of the multi-function units 120 is connected to at least one millimeter wave radio frequency circuit 621 and at least one non-millimeter wave radio frequency circuit 622, and different multi-function units 120 are connected to different radio frequency circuits 620, so that the multi-function units 120 are separately controlled through the radio frequency circuits 620.

In some embodiments, the orthographic projection of two or more of the multi-function units 120 on the base plate 11 is located within the orthographic projection of the blocking layer 200 on the base plate 11.

In some embodiments, the display panel 10 further includes a reflecting group with a plurality of reflecting units 110 which are connected to the control circuits 610 for controlling the reflecting units 110 to reflect signals. Optionally, the reflecting units 110 and the multi-function units 120 are connected to different control circuits 610, and for example, the reflecting units 110 and the multi-function units 120 are each connected to one control circuit 610, then the number of the control circuits 610 is the sum of the number of the reflecting units 110 and the number of the multi-function units 120, the reflecting units 110 are arranged in one-to-one correspondence with the control circuits 610, and the multi-function units 120 are arranged in one-to-one correspondence with the control circuits 610. In these optional embodiments, the wireless communication performance of the wireless communication apparatus can be further improved by adding the reflecting units 110 which are only for reflecting wireless signals.

In some embodiments, the orthographic projection of the reflecting units 110 on the base plate 11 is located within the orthographic projection of the blocking layer 200 on the base plate 11, so that the blocking layer 200 can further block the wireless signals that are not reflected by the reflecting units 110.

In some embodiments, the plurality of reflecting units 110 within the reflecting group are distributed in an array, and the multi-function units 120 are located at at least one side of the periphery of the reflection group. That is, the multi-function units 120 reused as the antenna and the reflecting surface are arranged at the periphery of the reflecting group which is only used to reflect wireless signals, and the multi-function units 120 are arranged closer to the edge of the display panel, so as to reduce the effect of the multi-function units 120 on the display of the display panel.

In some embodiments, at least a portion of the multi-function units 120 and the reflecting units 110 are arranged in a same layer, and for example, all of the multi-function units 120 and the reflecting units 110 are arranged in a same layer, and the reflecting units 110 are also arranged in the functional layer 100, so that the multi-function units 120 and the reflecting units 110 can be manufactured in a same process step, which can simplify the manufacturing process of the display panel.

In some embodiments, for the multi-function unit 120 and the reflecting unit 110 arranged in a same layer, the size and shape of the orthographic projection of the multi-function unit 120 on the base plate 11 are the same as the size and shape of the orthographic projection of the reflecting unit 110 on the base plate 11, so as to simplify the shape arrangement of the multi-function unit 120 and the reflecting unit 110 arranged in the same layer.

In some embodiments, the reflecting units 110 are arranged in the display area of the display panel, and the light transmittance of the reflecting units 110 is greater than or equal to 50%, so as to reduce the effect of the reflecting units 110 on the display of the wireless communication apparatus.

In some embodiments, the functional layer 100 and the blocking layer 200 each include a transparent layer structure, so as to reduce the effect of the functional layer and the blocking layer on the display of the wireless communication apparatus.

In other embodiments, if the reflecting units 110 are arranged in the non-display area of the display panel, the light transmittance of the reflecting units 110 is not limited.

In some embodiments, the multi-function control feeder line 820 and the multi-function unit 120 may be arranged in a same layer, so as to reduce the number of layer structures of the display panel 10.

Alternatively, the multi-function control feeder line 820 and the multi-function unit 120 may be arranged in different layers, so that the arrangement of the multi-function unit 120 and the arrangement of the multi-function control feeder line 820 do not affect each other.

In some embodiments, the display panel 10 further includes a control line 300 for connecting the reflecting unit 110 to the control circuit 610, i.e., the control line 300 is also used to connect the reflecting unit 110 to the control circuit 610. The control line 300 and the multi-function control feeder line 820 are arranged in a same layer, so that the control line 300 and the multi-function control feeder line 820 can be manufactured in a same process step, which can simplify the manufacturing process of the display panel 10. In some other embodiments, the control line 300 and the multi-function control feeder line 820 may be arranged in different layers, so as to enable the control line 300 and the multi-function control feeder line 820 to be arranged more flexibly.

In some embodiments, as described above, the display panel 10 further includes the radio frequency line 810, and the multi-function unit 120 connected with the radio frequency line 810 and the multi-function unit 120 connected with the multi-function control feeder line 820 may be the same or different. In order to simplify the structure of the display panel 10, the multi-function units 120 connected with the radio frequency line 810 and the multi-function control feeder line 820 may be different. Optionally, the multi-function unit 120 connected with the radio frequency line 810 is further connected with the control line 300. That is, for a plurality of multi-function units 120, a portion of the multi-function units 120 can be connected to the radio frequency circuit 620 and the control circuit 610 through the multi-function control feeder line 820, and another portion of the multi-function units 120 can be connected to the radio frequency circuit 620 through the radio frequency line 810 and to the control circuit 610 through the control line 300.

In some embodiments, at least two of the radio frequency line 810, the control line 300, and the multi-function control feeder line 820 are arranged in a same layer, so as to simplify the manufacturing process of the display panel 10.

The number of the functional layer 100 may be set in various ways. For example, as shown in FIGS. 1 to 11, the number of the functional layer 100 is one, and two or more multi-function units 120 are distributed in an array in the one functional layer 100. Optionally, the number of the blocking layer 200 is one.

In some other embodiments, as shown in FIG. 14, the number of the functional layers 100 is two or more, and the orthographic projections of at least two multi-function units 120 located in different functional layers 100 on the base plate 11 are of different areas.

In these embodiments, by arranging two or more functional layers 100 and arranging multi-function units 120 of different sizes in different functional layers 100, the multi-function units 120 can reflect wireless signals in different frequency bands or transmit antenna signals in different frequency bands, and thus the wireless communication performance of the wireless communication apparatus can be further improved.

In some embodiments, the reflecting units 110 are also arranged in the functional layers 100, the reflecting unit 110 is arranged in each of the two or more functional layers 100, and the orthographic projections of at least two reflecting units 110 located in different functional layers 100 are of different areas. The reflecting units 110 of different sizes can reflect wireless signals in different frequency bands, and thus the wireless communication performance of the wireless communication apparatus is further improved.

In some embodiments, the orthographic projections of two or more multi-function units 120 within a same functional layer 100 on the base plate 11 are of a same area, i.e., the two or more multi-function units 120 within the same functional layer 100 are of a same size, so that the two or more multi-function units 120 within the same functional layer 100 can reflect wireless signals in a same frequency band, and thus the ability of reflecting wireless signals in a same frequency band is improved.

In some embodiments, the orthographic projections of two or more reflecting units 110 within a same functional layer 100 on the base plate 11 are of a same area, i.e., the two or more reflecting units 110 within the same functional layer 100 are of a same size, so that the two or more reflecting units 110 within the same functional layer 100 can reflect wireless signals in a same frequency band, and thus the ability of reflecting wireless signals in a same frequency band is improved.

In some embodiments, for the reflecting unit 110 and the multi-function unit 120 within a same functional layer 100, the area of the orthographic projection of the reflecting unit 110 on the base plate 11 is the same as the area of the orthographic projection of the multi-function unit 120 on the base plate 11, so as to simplify the structure of the wireless communication apparatus. In addition, the ability of reflecting wireless signals in a same frequency band can also be improved.

In some embodiments, if the number of the functional layers 100 is two or more, the two or more functional layers 100 include a first functional layer 101 and a second functional layer 102, i.e., one of the two or more functional layers 100 is the first functional layer 101 and another is the second functional layer 102. The multi-function units 120 include at least one first multi-function unit 121 located in the first functional layer 101 and at least one second multi-function unit 121 located in the second functional layer 102, in which the first functional layer 101 is located at a side of the second functional layer 102 facing the display surface of the display panel 10, and the area of the orthographic projection of the first multi-function unit 121 on the base plate 11 is less than the area of the orthographic projection of the second multi-function unit 122 on the base plate 11.

In these embodiments, the first multi-function units 121 are located at a side of the second multi-function units 122 facing the display surface of the display panel 10, and the size of the first multi-function unit 121 is less than the size of the second multi-function unit 122, therefore wireless signals in a plurality of frequency bands can be reflected, so that the display panel 10 can regulate reflected signals for wireless signals in different frequency bands.

In some embodiments, the reflecting units 110 includes first reflecting units 111 located in the first functional layer 101 and second reflecting units 112 located in the second functional layer 102, in which the area of the orthographic projection of the first reflecting unit 111 on the base plate 11 is less than the area of the orthographic projection of the second reflecting unit 112 on the base plate 11. On the one hand, at least a portion of the second reflecting units 112 are not blocked by the first reflecting units 111, and the second reflecting units 112 can also reflect wireless signals; on the other hand, the size of the first reflecting unit 111 and the size of the second reflecting unit 112 are different, therefore wireless signals in a plurality of frequency bands can be reflected, so that the display panel 10 can regulate reflected signals for wireless signals in different frequency bands.

In some embodiments, the orthographic projection of the first multi-function unit 121 on the base plate 11 at least partially overlaps the orthographic projection of the second multi-function unit 122 on the base plate 11, so as to reduce the overall distribution area of two or more multi-function units 120 and to reflect wireless signals in a plurality of frequency bands. The orthographic projection of the first multi-function unit 121 on the base plate 11 at least partially overlapping the orthographic projection of the second multi-function unit 122 on the base plate 11 includes: the first multi-function units 121 and the second multi-function units 122 are arranged in one-to-one correspondence, and the orthographic projection of the first multi-function unit 121 on the base plate 11 at least partially overlaps the orthographic projection of the second multi-function unit 122 on the base plate 11. Alternatively, two or more first multi-function units 121 are arranged corresponding to a same second multi-function unit 122, or a same first multi-function unit 121 is arranged corresponding to two or more second multi-function units 122, as long as the orthographic projection of each first multi-function unit 121 on the base plate 11 can at least partially overlap the orthographic projection of at least one second multi-function unit 122 on the base plate 11, and the orthographic projection of each second multi-function unit 122 on the base plate 11 can at least partially overlap the orthographic projection of at least one first multi-function unit 121 on the base plate 11.

In some embodiments, the orthographic projection of the first reflecting unit 111 on the base plate 11 at least partially overlaps the orthographic projection of the second reflecting unit 112 on the base plate 11, so as to reduce the overall distribution area of two or more reflecting units 110, to reduce the size of the reflecting surface assembly, and to reflect wireless signals in a plurality of frequency bands. The orthographic projection of the first reflecting unit 111 on the base plate 11 at least partially overlapping the orthographic projection of the second reflecting unit 112 on the base plate 11 includes: the first reflecting units 111 and the second reflecting units 112 are arranged in one-to-one correspondence, and the orthographic projection of the first reflecting unit 111 on the base plate 11 at least partially overlaps the orthographic projection of the second reflecting unit 112 on the base plate 11. Alternatively, two or more first reflecting units 111 are arranged corresponding to a same second reflecting unit 112, or a same first reflecting unit 111 is arranged corresponding to two or more second reflecting units 112, as long as the orthographic projection of each first reflecting unit 111 on the base plate 11 can at least partially overlap the orthographic projection of at least one second reflecting unit 112 on the base plate 11, and the orthographic projection of each second reflecting unit 112 on the base plate 11 can at least partially overlap the orthographic projection of at least one first reflecting unit 111 on the base plate 11.

In some embodiments, the size and shape of the first reflecting unit 111 are the same as the shape and size of the first multi-function unit 121, and the shape and size of the second reflecting unit 112 are the same as the shape and size of the second multi-function unit 122, so as to simplify the structure of the display panel.

In some embodiments, the number correspondence between the first reflecting units 111 and the second reflecting units 112 is the same as the number correspondence between the first multi-function units 121 and the second multi-function units 122. For example, if the first reflecting units 111 and the second reflecting units 112 are arranged in one-to-one correspondence, the first multi-function units 121 and the second multi-function units 122 are arranged in one-to-one correspondence.

In some embodiments, the display panel further includes a connecting portion 400 arranged in an overlapping area between the first multi-function unit 121 and the second multi-function unit 122, one end of the connecting portion 400 is connected to the first multi-function unit 121 and the second multi-function unit 122, and the other end of the connecting portion 400 is connected to the control circuit 610 and/or the radio frequency circuit 620. In some embodiments, the connecting portion 400 is reused as a portion of at least one of the multi-function control feeder line 820, the control line 300, and the radio frequency line 810.

In these embodiments, the connecting portion 400 is arranged in an overlapping area between the first multi-function units 121 and the second multi-function units 122, so that the connecting portion 400 can be connected to both the first multi-function units 121 and the second multi-function units 122 by extending along the thickness direction of the display panel 10, which can simplify the structure of the connection portion 400.

In some embodiments, the connecting portion 400 is further arranged in an overlapping area between the first reflecting units 111 and the second reflecting units 112, and one end of the connecting portion 400 is connected to the first reflecting units 111 and the second reflecting units 112, and the other end of the connecting portion 400 is connected to the control line 300, so that the connecting portion 400 can be connected to both the first reflecting units 111 and the second reflecting units 112 by extending along the thickness direction of the display panel 10, which can simplify the structure of the connection portion 400.

In some embodiments, the shape of the orthographic projection of the first reflecting unit 111 on the base plate 11 and the shape of the orthographic projection of the second reflecting unit 112 on the base plate 11 may be the same or different. For example, the orthographic projection of the second reflecting unit 112 on the base plate 11 is rectangular, and the orthographic projection of the first reflecting unit 111 on the base plate 11 may be rectangular, circular or the like.

In some embodiments, the first multi-function units 121 and the second multi-function units 122 may be arranged in one-to-one correspondence. Alternatively, since the size of the first multi-function unit 121 is less than the size of the second multi-function unit 122, two or more first multi-function units 121 are arranged corresponding to a same second multi-function unit 122.

In some embodiments, as shown in FIG. 15, two or more first multi-function units 121 are arranged corresponding to a same second multi-function unit 122, and for the two or more first multi-function units 121 and the corresponding second multi-function unit 122, the orthographic projection of the two or more first multi-function units 121 on the base plate 11 is located within the orthographic projection of the same second multi-function unit 122 on the base plate 11.

In these embodiments, since the size of the first multi-function unit 121 is small, two or more first multi-function units 121 are arranged corresponding to a same second multi-function unit 122, which can increase the number of the arranged first multi-function units 121 and improve the wireless communication performance of the first functional layer 101. The orthographic projection of the two or more first multi-function units 121 on the base plate 11 is located within the orthographic projection of the same second multi-function unit 122 on the base plate 11, so that the arrangement of the first multi-function units 121 and the second multi-function units 122 is more regular, which facilitates the manufacturing.

In some embodiments, the first reflecting units 111 and the second reflecting units 112 may be arranged in one-to-one correspondence. Alternatively, since the size of the first reflecting unit 111 is less than the size of the second reflecting unit 112, two or more first reflecting units 111 are arranged corresponding to a same second reflecting unit 112.

In some embodiments, as shown in FIG. 15, two or more first reflecting units 111 are arranged corresponding to a same second reflecting unit 112, and for the two or more first reflecting units 111 and the corresponding second reflecting unit 112, the orthographic projection of the two or more first reflecting units 111 on the base plate 11 is located within the orthographic projection of the same second reflecting unit 112 on the base plate 11.

In these embodiments, since the size of the first reflecting unit 111 is small, two or more first reflecting units 111 are arranged corresponding to a same second reflecting unit 112, which can increase the number of the arranged first reflecting units 111 and improve the wireless communication performance of the first functional layer 101. The orthographic projection of the two or more first reflecting units 111 on the base plate 11 is located within the orthographic projection of the same second reflecting unit 112 on the base plate 11, so that the arrangement of the first reflecting units 111 and the second reflecting units 112 is more regular, which facilitates the manufacturing.

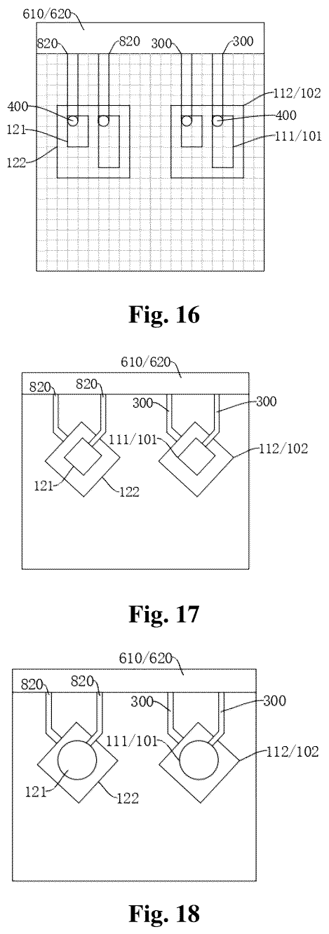

In some embodiments, as shown in FIG. 16, for the two or more first multi-function units 121 and the corresponding second multi-function unit 122, the projections of the two or more first multi-function units 121 on the base plate 11 are of different areas, so that the two or more first multi-function units 121 corresponding to the same second multi-function unit 122 can reflect wireless signals in different frequency bands or transmit antenna signals in different frequency bands, so as to further improve the wireless communication performance of the display panel 10.

In some embodiments, for the two or more first reflecting units 111 and the corresponding second reflecting unit 112, the projections of the two or more first reflecting units 111 on the base plate 11 are of different areas, so that the two or more first reflecting units 111 corresponding to the same second reflecting unit 112 can reflect wireless signals in different frequency bands, so as to further improve the wireless communication performance of the display panel 10.

In some other embodiments, as shown in FIG. 15, for the two or more first multi-function units 121 and the corresponding second multi-function unit 122, the projections of the two or more first multi-function units 121 on the base plate 11 may be of a same area. In some other optional embodiments, for the two or more first reflecting units 111 and the corresponding second reflecting unit 112, the projections of the two or more first reflecting units 111 on the base plate 11 may be of a same area.

In some embodiments, as shown in FIGS. 17 and 18, the shape of the orthographic projection of the first multi-function unit 121 on the base plate 11 and the shape of the orthographic projection of the second multi-function unit 122 on the base plate 11 may be the same or different. For example, the orthographic projection of the second multi-function unit 122 on the base plate 11 is rectangular, and the orthographic projection of the first multi-function unit 121 on the base plate 11 may be rectangular, circular or the like.

FIGS. 14 to 18 illustrate only one second multi-function unit 122, but in other embodiments, the number of the second multi-function units 122 may be two or more, and the plurality of second multi-function units 122 are arranged at intervals. In addition, FIGS. 14 to 18 illustrate only one second reflecting unit 112, but in other embodiments, the number of the second reflecting units 112 may be two or more, and the plurality of second reflecting units 112 are arranged at intervals.

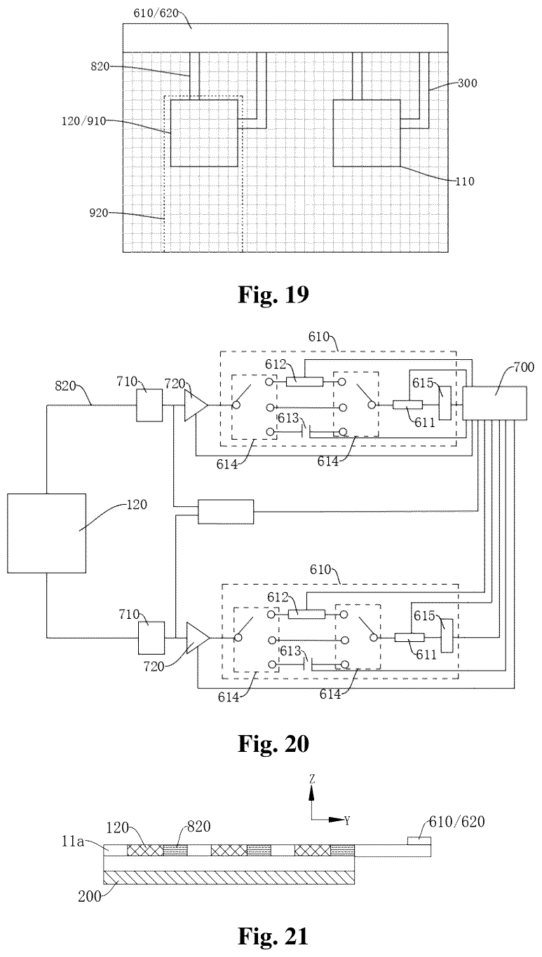

In some embodiments, one multi-function unit 120 may be connected to one control circuit 610, or as shown in FIGS. 19 and 20, one multi-function unit 120 may be connected to two or more control circuits 610, so that the multi-function unit 120 is altered by the two or more control circuits 610 to have different electrical loads, and in turn amplitude adjustment, phase adjustment and the like may be performed on the multi-function unit 120. In some embodiments, one reflecting unit 110 may be connected to one control circuit 610, or one reflecting unit 110 may be connected to two or more control circuits 610, so that the reflecting unit 110 is altered by the two or more control circuits 610 to have different electrical loads, and in turn amplitude adjustment, phase adjustment and the like may be performed on the reflecting unit 110.

In some embodiments, if one multi-function unit 120 is configured to be connected to two or more control circuits 610, the multi-function unit 120 is connected with two or more control lines 300, and the multi-function unit 120 is connected to the control circuits 610 through the control lines 300. Alternatively, the multi-function unit 120 is connected with two or more multi-function control feeder lines 820, and the multi-function unit 120 is connected to the control circuits 610 through the two or more multi-function control feeder lines 820. If one multi-function unit 120 is connected with two or more control lines 300 or multi-function control feeder lines 820, the two or more control lines 300 or multi-function control feeder lines 820 are arranged at intervals on the multi-function unit 120, so as to reduce the mutual effect between the two or more control lines 300 or multi-function control feeder lines 820.

In some embodiments, if one reflecting unit 110 is connected to two or more control circuits 610, the reflecting unit 110 is connected with two or more control lines 300, and the two or more control lines 300 are arranged at intervals on the reflecting unit 110, so as to reduce the mutual effect between the two or more control lines 300.

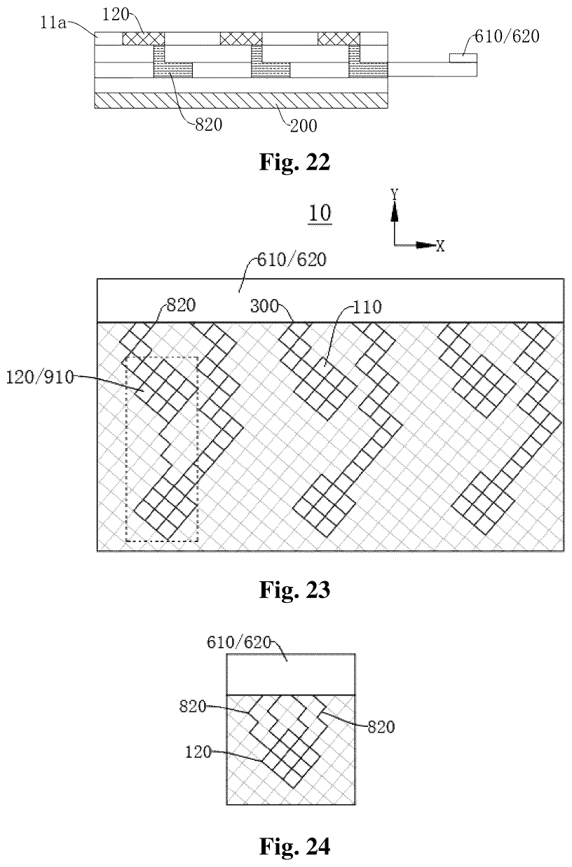

In some embodiments, as shown in FIGS. 1 and 21, the display panel 10 further includes a signal line layer 11a. The multi-function unit 120 and the multi-function control feeder line 820 may be arranged in a same layer and both located in the signal line layer 11a, so as to simplify the structure of the display panel 10. Alternatively, as described above, if the multi-function unit 120 and the multi-function control feeder line 820 are located in different layers, as shown in FIG. 22, the multi-function unit 120 is arranged in the signal line layer 11a, and the multi-function control feeder line 820 is arranged in another conductive layer. Alternatively, the multi-function control feeder line 820 is arranged in the signal line layer 11a, and the multi-function unit 120 is arranged in another conductive layer.

In some embodiments, the multi-function control feeder line 820 may be arranged in a conductive layer located at a side of the functional layer 100 away from the blocking layer 200, and for example, the multi-function control feeder line 820 is arranged in a signal line layer 11a which may be located at the side of the functional layer 100 away from the blocking layer 200. Alternatively, the multi-function control feeder line 820 may be arranged in a conductive layer located between the functional layer 100 and the blocking layer 200, and for example, the multi-function control feeder line 820 is arranged in a signal line layer 11a which may be located between the functional layer 100 and the blocking layer 200. In some embodiments, the reflecting unit 110 and the multi-function unit 120 are located in a same layer, and the control line 300 connected to the reflecting unit 110 may be located in the same layer as the multi-function control feeder line 820.

The signal line layer 11a may be set in various ways, and for example, as shown in FIGS. 1 to 16, the signal line layer 11a includes grid metal wirings, and at least a portion of the metal wirings are reused as at least one of the multi-function unit 120, the multi-function control feeder line 820, the reflecting unit 110, the control line 300, and the radio frequency line 810. The grid metal wirings include a plurality of first signal lines extending along the first direction X and a plurality of second signal lines extending along the second direction Y, and the first signal lines and the second signal lines intersect to form a grid.

If a portion of the metal wirings are reused as at least one of the multi-function unit 120, the multi-function control feeder line 820, the reflecting unit 110, the control line 300, and the radio frequency line 810, this portion of the metal wirings are insulated from the metal wirings at the other locations, as to avoid short-circuit connection between adjacent ones of the multi-function unit 120, the multi-function control feeder line 820, the reflecting unit 110, the control line 300, and the radio frequency line 810.

In some embodiments, as shown in FIGS. 23 and 24, the extension direction of the grid metal wiring intersects the length direction of the display panel 10. The extension direction of the grid metal wiring may be the extension direction of the first signal line or the extension direction of the second signal line. The display panel 10 includes first side edges and second side edges, and two first side edges and two second side edges are alternately connected to enclose and form the display panel 10. The length of the first side edge is greater than the length of the second side edge, and the extension direction of the first side edge may be the length direction of the display panel 10. The extension direction of the grid metal wiring intersects the length direction of the display panel 10, i.e., the extension direction of the first signal line and/or the second signal line intersects the extension direction of the first side edge, which can reduce the effect of the grid metal wirings on the display of the display panel 10.

In some other embodiments, as shown in FIGS. 16, 17, and. 25, the display panel 10 further includes a light-transmitting conductive layer 11b, and for example, the material of the light-transmitting conductive layer 11b includes a light-transmitting conductive material such as indium-tin oxide, so as to increase the light transmittance of the light-transmitting conductive layer 11b. The light-transmitting conductive layer 11b has high light transmittance and is conductive.

In some embodiments, at least one of the multi-function unit 120, the multi-function control feeder line 820, the reflecting unit 110, the control line 300, the radio frequency line 810, and the blocking layer 200 is arranged in the light-transmitting conductive layer 11b, so as to reduce the effect of at least one of the multi-function unit 120, the multi-function control feeder line 820, the reflecting unit 110, the control line 300, the radio frequency line 810, and the blocking layer 200 on the display of the display panel 10.

In some embodiments, the light-transmitting conductive layer 11b includes a first conductive layer and a second conductive layer that are stacked, at least one of the multi-function unit 120 and the reflecting unit 110 is arranged in the first conductive layer, and one or more light-blocking units are arranged in the second conductive layer.

In some embodiments, as shown in FIG. 26, the base plate 11 includes an array base plate 11c and a common electrode layer 11d, in which the common electrode layer 11d is located at a side of the array base plate 11c facing the display surface of the display panel 10, and the common electrode layer 11d is reused as the blocking layer 200. Therefore, the blocking layer 200 can reuse the original layer structure of the display panel 10, and the structure of the display panel 10 can be simplified.

In some embodiments, the array base plate 11c includes a substrate and a driving circuit arranged on the substrate. Optionally, a planarizing layer, a pixel electrode layer, and a pixel defining layer are arranged on the base plate 11. The pixel electrode layer includes a plurality of pixel electrodes distributed in an array on the planarizing layer, the pixel defining layer is located at a side of the pixel electrode layer away from the planarizing layer and includes pixel defining portions and pixel openings enclosed by the pixel defining portions, and light-emitting units 11e may be arranged within the pixel openings. The common electrode layer 11d is arranged at a side of the pixel defining portions and the light-emitting units 11e away from the planarizing layer.

In some embodiments, an encapsulation layer and a touch control layer are further arranged at a side of the common electrode layer 11d away from the pixel defining layer, and the multi-function units 120 and the reflecting units 110 may be arranged in the touch control layer, so as to further simplify the structure of the display panel 10.

As shown in FIGS. 27 to 31, some embodiments of the present application further provide a wireless communication apparatus including the display panel 10 of any of the above embodiments of the first aspect. Since the wireless communication apparatus according to the embodiments of the present application includes the display panel 10 of any of the above embodiments of the first aspect, the wireless communication apparatus according to the embodiments of the present application has the same beneficial effects as those of the display panel 10 of any of the above embodiments of the first aspect, which will not be repeated herein.

The wireless communication apparatus of the embodiments of the present application includes, but is not limited to, a cellular phone, a wireless wearable device, a Personal Digital Assistant (PDA), a tablet computer, an e-book, a television, an access control, a smart landline phone, a console, an electronic display board, a transparent-substrate display board, and other devices with display function.

In some embodiments, the wireless communication apparatus further includes the control assembly 600 as described above, and the multi-function unit 120 is controlled by the radio frequency circuit 620 and the control circuit 610 of the control assembly 600 to transmit antenna signals or reflect wireless signals.

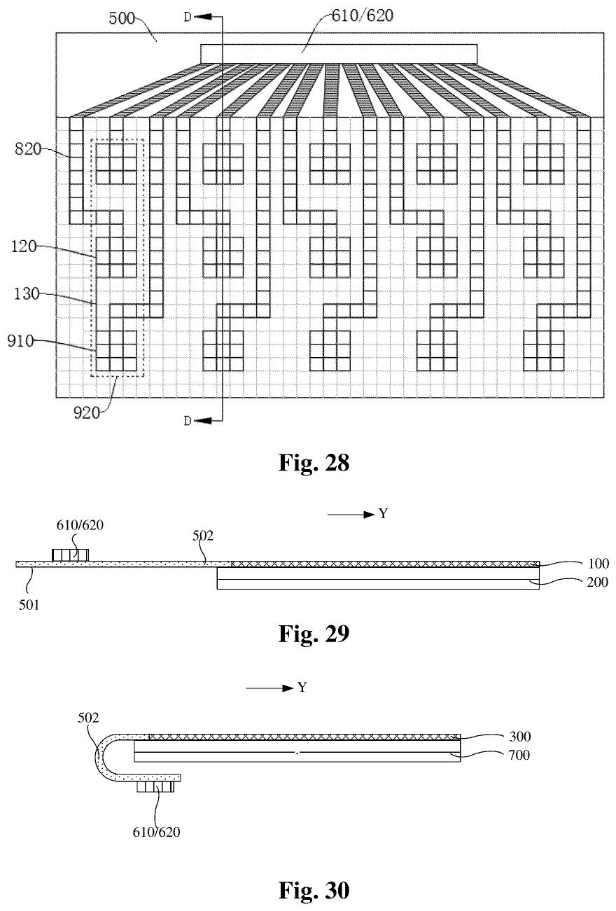

In some embodiments, as shown in FIGS. 28 to 31, the wireless communication apparatus further includes a circuit board 500, which may be a flexible circuit board. At least one of the control circuit 610, the millimeter wave radio frequency circuit 621, and the non-millimeter wave radio frequency circuit 622 is arranged on the circuit board 500. The circuit board 500 can support at least one of the control circuit 610, the millimeter wave radio frequency circuit 621, and the non-millimeter wave radio frequency circuit 622.

In some embodiments, the circuit board 500 includes a folded area 502 and a mounting area 501, in which the folded area 502 is folded so that the mounting area 501 is located at the non-display side of the display panel 10, and at least one of the control circuit 610, the millimeter wave radio frequency circuit 621, and the non-millimeter wave radio frequency circuit 622 is arranged in the mounting area 501. Therefore, the number of the components located at the display side can be reduced, and the display area of the wireless communication apparatus is increased.

The number of the circuit board 500 may be set in various ways. For example, the number of the circuit board 500 may be one, and the control circuit 610, the millimeter wave radio frequency circuit 621, and the non-millimeter wave radio frequency circuit 622 are arranged on the same circuit board 500. Alternatively, the number of the circuit boards 500 is two or more, at least two of the control circuit 610, the millimeter wave radio frequency circuit 621, and the non-millimeter wave radio frequency circuit 622 are arranged on different circuit boards 500, and for example, the control circuit 610 is arranged on one of the circuit boards 500, while the millimeter wave radio frequency circuit 621 and the non-millimeter wave radio frequency circuit 622 are arranged on another of the circuit boards 500. The control circuit 610 is configured to control the multi-function units 120 to reflect wireless signals, and the control circuit 610 and the radio frequency circuit 620 being arranged on different circuit boards 500 can reduce signal crosstalk. In addition, the millimeter wave radio frequency circuit 621 and the non-millimeter wave radio frequency circuit 622 are both configured to control the multi-function units 120 to transmit antenna signals, and the millimeter wave radio frequency circuit 621 and the non-millimeter wave radio frequency circuit 622 being arranged on the same circuit board 500 can simplify the structure of the wireless communication apparatus.

In some embodiments, if the display panel 10 includes the multi-function control feeder lines 820, the radio frequency circuit 620 and the control circuit 610 are both arranged on the circuit board 500. Optionally, a first signal line and a second signal line are arranged on the circuit board 500, in which the first signal line connects the multi-function control feeder lines 820 to the radio frequency circuit 620, and the second signal line connects the multi-function control feeder lines 820 to the control circuit 610. Optionally, if the radio frequency circuit 620 includes the millimeter wave radio frequency circuit 621 and the non-millimeter wave radio frequency circuit 622, the second signal line includes a first sub-line and a second sub-line, in which the first sub-line connects the multi-function control feeder lines 820 to the millimeter wave radio frequency circuit 621, and the second sub-line connects the non-millimeter wave radio frequency circuit 622 to the multi-function control feeder lines 820. In some embodiments, the multi-function control feeder lines 820 are arranged in the base plate 11, and for example, the multi-function control feeder lines 820 may be arranged within the base plate 11 of the display panel 10, while the radio frequency circuit 620 and the control circuit 610 are arranged on the circuit board 500. The multi-function control feeder lines 820 within the display panel 10 are connected to the radio frequency circuit 620 and the control circuit 610 via the first signal line and the second signal line on the flexible circuit board 500, respectively.

In some embodiments, as shown in FIGS. 8, 10, 13, and 20, the wireless communication apparatus further includes a baseband 700, which is configured to control the multi-function unit 120 and the control circuit 610 to be electrically connected or disconnected. If the multi-function unit 120 is reused as a reflecting surface assembly and configured to reflect wireless signals, the baseband 700 controls the multi-function unit 120 and the control circuit 610 to be electrically connected; and if the multi-function unit 120 is reused as the antenna assembly 900, the baseband 700 controls the multi-function unit 120 and the control circuit 610 to be electrically disconnected. Herein, the “connected” and “disconnected” refer to the connect and disconnect of electrical connection, when the multi-function unit 120 and the control circuit 610 are electrically connected, the control circuit 610 is able to change the electrical load of the multi-function unit 120, and when the multi-function unit 120 and the control circuit 610 are electrically disconnected, the control circuit 610 is not able to change the electrical load of the multi-function unit 120.

The baseband 700 may control the multi-function unit 120 and the control circuit 610 to be electrically connected or disconnected in various ways, and for example, the baseband 700 controls the multi-function unit 120 and the control circuit 610 to be electrically connected or disconnected in accordance with a preset time sequence and time period. For example, the baseband 700 controls the multi-function unit 120 and the control circuit 610 to be electrically connected for a time period t1, then controls the multi-function unit 120 and the control circuit 610 to be electrically disconnected for a time period t2, and then controls the multi-function unit 120 and the control circuit 610 to be electrically connected for the time period t1, and so on. The time period t1 and the time period t2 may be the same or different.

In some embodiments, if the wireless communication apparatus includes the circuit board 500 connected with the display panel 10, the baseband 700 may be arranged on the circuit board 500. The control circuit 610, the radio frequency circuit 620, and the baseband 700 may be arranged on a same circuit board 500, or at least two of the control circuit 610, the radio frequency circuit 620, and the baseband 700 may be arranged on a same circuit board 500, or the control circuit 610, the radio frequency circuit 620, and the baseband 700 may be arranged on different flexible circuit boards 500.

In some other optional embodiments, the display panel 10 further includes the reflecting units 110, and the baseband 700 is further configured to acquire a first radio frequency operating current of the multi-function unit 120 and a second radio frequency operating current of at least one of the reflecting units 110. The baseband 700 is further configured to control the multi-function unit 120 and the control circuit 610 to be electrically disconnected if the absolute value of the difference between the first radio frequency operating current and the second radio frequency operating current is greater than or equal to a first preset threshold.

When the multi-function unit 120 is reused as the antenna assembly 900, the operating current within the multi-function unit 120 is different from the operating current within the reflecting unit 110 which is only used to reflect wireless signals. In these optional embodiments, the baseband 700 can acquire the first radio frequency operating current and the second radio frequency operating current, and if the absolute value of the difference between the first radio frequency operating current and the second radio frequency operating current is greater than the first preset threshold, the operating current of the multi-function unit 120 and the operating current of the reflecting unit 110 differ too much, the multi-function unit 120 is reused as the antenna assembly 900, and the baseband 700 controls the multi-function unit 120 and the control circuit 610 to electrically disconnected, so as to enable the multi-function unit 120 to be in the operating mode of the antenna assembly 900.

The first preset threshold may be set according to the user's actual usage requirements, and may be determined in connection with the dynamic range of the radio frequency device connected with the antenna assembly 900 for which the multi-function unit 120 is to be reused as, the dynamic range of the radio frequency device connected with the reflecting unit 110, and the sensitivity of the baseband platform, as long as the multi-function unit 120 is determined to be currently reused as the antenna assembly 900 rather than the reflecting surface assembly when the absolute value of the difference between the radio frequency currents is greater than or equal to the first preset threshold.

In some embodiments, the baseband 700 is further configured to control the multi-function unit 120 and the control circuit 610 to be electrically connected when the absolute value of the difference between the first radio frequency operating current and the second radio frequency operating current is less than the first preset threshold. That is, if the absolute value of the difference between the radio frequency currents is less than the first preset threshold, the operating current of the multi-function unit 120 and the radio frequency operating current of the reflecting unit 110 do not differ too much, the multi-function unit 120 is reused as the reflecting surface assembly and reflects wireless signals together with the reflecting unit 110, therefore the multi-function unit 120 and the control circuit 610 are electrically connected, and the control circuit 610 can control the operating state of the multi-function unit 120 when it is reused as the reflecting surface assembly.

In some embodiments, the baseband 700 is further configured to acquire the radio frequency operating current of the reflecting unit 110 adjacent to the multi-function unit 120 as the second radio frequency operating current, i.e., the baseband 700 is configured to acquire the first radio frequency operating current of the multi-function unit 120 and the second radio frequency operating current of the reflecting unit 110 adjacent to the multi-function unit 120. The operating current of the reflecting unit 110 adjacent to the multi-function unit 120 is used to determine whether the multi-function unit 120 is reused as the reflecting surface, so that the accuracy of the determination can be improved, and in turn the control accuracy of the baseband 700 is improved.

In some embodiments, the wireless communication apparatus further includes a low noise amplifier 720 connected between the baseband 700 and the multi-function unit 120 and/or the reflecting unit 110, so as to reduce the effect of noise signals on the control accuracy. The baseband 700 may control the multi-function unit 120 and the control circuit 610 to be electrically connected or disconnected by controlling the low noise amplifier 720. The low noise amplifier 720 may be connected between the multi-function unit 120 and the baseband 700, or between the reflecting unit 110 and the baseband 700, or between the multi-function unit 120 and the baseband 700 and between the reflecting unit 110 and the baseband 700. Optionally, a filter 710 is further included and connected between the baseband 700 and the multi-function unit 120 and/or the reflecting unit 110.

The control circuit 610 may be set in various ways, and in some optional embodiments, the control circuit 610 includes a variable resistor 611 connected between the baseband 700 and the multi-function unit 120 and/or the reflecting unit 110. If the control circuit 610 is configured to control the multi-function unit 120, the variable resistor 611 is connected between the multi-function unit 120 and the baseband 700, and the amplitude of the multi-function unit 120 when it is located in the reflecting surface can be adjusted by adjusting the resistance value of the variable resistor 611. If the control circuit 610 is configured to control the reflecting unit 110, the variable resistor 611 is connected between the reflecting unit 110 and the baseband 700, and the amplitude of the reflecting unit 110 can be adjusted by changing the resistance value of the variable resistor 611.

In some embodiments, if the wireless communication apparatus includes the low noise amplifier 720, the variable resistor 611 may be connected between the low noise amplifier 720 and the baseband 700.

In some embodiments, if the wireless communication apparatus includes the circuit board 500 and the display panel 10, the variable resistor 611 may be arranged in the display panel 10 or the circuit board 500.

In some embodiments, the control circuit 610 further includes a variable capacitor 613 and/or a variable inductor 612, which are connected between the multi-function unit 120 and the variable resistor 611. Additionally/alternatively, the variable capacitor 613 and/or the variable inductor 612 are connected between the reflecting unit 110 and the variable resistor 611. If the control circuit 610 is configured to control the multi-function unit 120, the variable capacitor 613 and/or the variable inductor 612 are connected between the multi-function unit 120 and the variable resistor 611, and if the control circuit 610 is configured to control the reflecting unit 110, the variable capacitor 613 and/or the variable inductor 612 are connected between the reflecting unit 110 and the variable resistor 611. Characteristics such as the phase of the multi-function unit 120 and/or the reflecting unit 110 can be controlled by arranging the variable capacitor 613 and/or the variable inductor 612 within the control circuit 610.

In some embodiments, the control circuit 610 further includes a second switch 614, which is configured to control the electrical connections between the variable resistor 611 and the multi-function unit 120 and/or the reflecting unit 110. For example, the second switch 614 may be configured to control the multi-function unit 120 and/or the reflecting unit 110 to be directly electrically connected to the variable resistor 611, or the multi-function unit 120 and/or the reflecting unit 110 to be electrically connected to the variable resistor 611 through the variable capacitor 613, or the multi-function unit 120 and/or the reflecting unit 110 to be electrically connected to the variable resistor 611 through the variable inductor 612.

For example, the second switch 614 is a single-pole multi-throw switch, one end of the second switch 614 is connected to the multi-function unit 120 and/or the reflecting unit 110, and the other end of the second switch 614 is provided with three lines, in which one line is directly electrically connected to the variable resistor 611, another line is electrically connected to the variable resistor 611 through the variable capacitor 613, and the last line is electrically connected to the variable resistor 611 through the variable inductor 612. The electrical connections between the variable resistor 611 and the multi-function unit 120 and/or the reflecting unit 110 may be determined by controlling the electrical connectivity within the second switch 614.

In some embodiments, the control circuit 610 further includes a down converter 615 which is connected between the variable resistor 611 and the baseband 700.

Some embodiments of the third aspect of the present application further provide a multi-function assembly including a functional layer 100, a blocking layer 200, and an antenna assembly 900. The functional layer 100 includes one or more multi-function units 120 for reflecting wireless signals; the blocking layer 200 is arranged at a side of the functional layer 100; and the antenna assembly 900 includes a non-millimeter wave antenna unit 920 and a millimeter wave antenna unit 910, the multi-function units 120 are reused as the millimeter wave antenna unit 910 and a portion of the non-millimeter wave antenna unit 920.

In the embodiments of the present application, the functional layer 100 includes multi-function units 120 which are capable of reflecting wireless signals, thereby improving the wireless performance of the multi-function assembly; the blocking layer 200 is arranged at a side of the functional layer 100 and used to block wireless signals incident from the backside the functional layer 100. The antenna assembly 900 includes a millimeter wave antenna unit 910 and a non-millimeter wave antenna unit 920, so that the multi-function assembly can transmit millimeter wave antenna signals and non-millimeter wave antenna signals, which can further enrich the wireless communication function of the multi-function assembly. In addition, the multi-function units 120 are reused as the millimeter wave antenna unit 910 and a portion of the non-millimeter wave antenna unit 920, and thus the structure of the multi-function assembly can be simplified.

The arrangement of the functional layer 100, the blocking layer 200, and the antenna assembly 900 in the multi-function assembly is the same as those described above, and will not be repeated herein.

What is claimed is:

1. A display panel, comprising:
a base plate;
a functional layer arranged on the base plate and comprising one or more multi-function units for reflecting wireless signals;
a blocking layer arranged at a side of the multi-function units facing the base plate; and
an antenna assembly arranged on the base plate and located at a side of the blocking layer away from the base plate, the antenna assembly comprising a non-millimeter wave antenna unit and a millimeter wave antenna unit, the multi-function units being reused as the millimeter wave antenna unit and the multi-function units being reused as a portion of the non-millimeter wave antenna unit.

2. The display panel according to claim 1, wherein a same one of the multi-function units is reused as the millimeter wave antenna unit and a portion of the non-millimeter wave antenna unit; or
at least one of the multi-function units is reused as the millimeter wave antenna unit, and at least another one of the multi-function units is reused as a portion of the non-millimeter wave antenna unit.

3. The display panel according to claim 2, wherein the antenna assembly comprises a plurality of non-millimeter wave antenna units and a plurality of millimeter wave antenna units.

4. The display panel according to claim 1, further comprising a multi-function control feeder line, wherein one end of the multi-function control feeder line is connected to the multi-function unit, and the other end of the multi-function control feeder line is configured to connect to a control circuit and a radio frequency circuit, so as to enable the control circuit and the radio frequency circuit to transmit a control signal to the multi-function unit via the multi-function control feeder line.

5. The display panel according to claim 4, further comprising a radio frequency line and a control line, wherein the radio frequency line is configured to connect the multi-function unit to the radio frequency circuit, the radio frequency line comprises a millimeter wave feeder line and a non-millimeter wave feeder line, the radio frequency circuit comprises a millimeter wave radio frequency circuit and a non-millimeter wave radio frequency circuit, the millimeter wave feeder line is configured to connect the multi-function unit to the millimeter wave radio frequency circuit, the non-millimeter wave feeder line is configured to connect the multi-function unit to the non-millimeter wave radio frequency circuit, the control line is configured to connect the multi-function unit to the control circuit, and the multi-function control feeder line is reused as at least two of the control line, the millimeter wave feeder line, and the non-millimeter wave feeder line.

6. The display panel according to claim 1, wherein two or more of the multi-function units are electrically connected to each other by a connecting signal line and reused as the non-millimeter wave antenna unit.

7. The display panel according to claim 6, wherein at least one non-millimeter wave antenna unit is connected to a first signal voltage.

8. The display panel according to claim 7, wherein at least one of the multi-function units reused as the non-millimeter wave antenna unit is connected to the first signal voltage, or at least a portion of the connecting signal line is connected to the first signal voltage.

9. The display panel according to claim 7, wherein the antenna assembly comprises a plurality of non-millimeter wave antenna units, and at least one of the plurality of non-millimeter wave antenna units is connected to the first signal voltage.

10. The display panel according to claim 1, further comprising one or more reflecting units for reflecting wireless signals, wherein a plurality of the reflecting units form a reflecting group, and the multi-function units are located at at least one side of a periphery of the reflecting group.

11. The display panel according to claim 10, wherein for the multi-function unit and the reflecting unit located in a same layer, a size of an orthographic projection of the multi-function unit on the base plate is the same as a size of an orthographic projection of the reflecting unit on the base plate.

12. The display panel according to claim 10, wherein the display panel comprises a display area, and a plurality of the reflecting units are distributed in an array in the display area.

13. The display panel according to claim 1, wherein the display panel comprises two or more functional layers, and areas of orthographic projections of at least two of the multi-function units located in different functional layers on the base plate are different.

14. The display panel according to claim 13, wherein areas of orthographic projections of a plurality of the multi-function units located in a same functional layer are the same.

15. The display panel according to claim 13, wherein at least two of the functional layers comprise the same number of the multi-function units.

16. The display panel according to claim 13, wherein two or more of the functional layers comprise a first functional layer and a second functional layer;
the multi-function units comprise at least one first multi-function unit located in the first functional layer and at least one second multi-function unit located in the second functional layer,
wherein the first functional layer is located at a side of the second functional layer facing a display surface of the display panel, an area of an orthographic projection of the first multi-function unit on the base plate is less than an area of an orthographic projection of the second multi-function unit on the base plate.

17. The display panel according to claim 16, wherein the orthographic projection of the first multi-function unit on the base plate at least partially overlaps the orthographic projection of the second multi-function unit on the base plate.

18. The display panel according to claim 16, further comprising a connecting portion arranged in an overlapping area between the first multi-function unit and the second multi-function unit, one end of the connecting portion being connected to the first multi-function unit and the second multi-function unit, and the other end of the connecting portion being configured to connect to a control circuit or a radio frequency circuit.

19. A wireless communication apparatus, comprising the display panel according to claim 1.

20. The wireless communication apparatus according to claim 19, further comprising a control assembly, wherein the control assembly comprises a control circuit and a radio frequency circuit, the radio frequency circuit comprises a millimeter wave radio frequency circuit and a non-millimeter wave radio frequency circuit, the control circuit is connected to the multi-function units for controlling the multi-function units to reflect wireless signals, the millimeter wave radio frequency circuit is connected to the multi-function units for controlling the multi-function units to transmit millimeter wave signals, and the non-millimeter wave radio frequency circuit is connected to the multi-function units for controlling the multi-function units to transmit non-millimeter wave signals.

21. The wireless communication apparatus according to claim 20, further comprising one or more flexible circuit boards, at least one of the control circuit, the millimeter wave radio frequency circuit, and the non-millimeter wave radio frequency circuit being arranged on the flexible circuit board.

22. The wireless communication apparatus according to claim 21, wherein the flexible circuit board comprises a folded area and a mounting area, the folded area is folded so that the mounting area is located at a non-display side of the display panel, and at least one of the control circuit, the millimeter wave radio frequency circuit, and the non-millimeter wave radio frequency circuit is arranged in the mounting area.

23. The wireless communication apparatus according to claim 21, wherein the number of the flexible circuit boards is two or more, the control circuit is arranged on one of the flexible circuit boards, and the millimeter wave radio frequency circuit and the non-millimeter wave radio frequency circuit are arranged on another one of the flexible circuit boards; or
the number of the flexible circuit boards is one, and the control circuit, the millimeter wave radio frequency circuit, and the non-millimeter wave radio frequency circuit are arranged on the same flexible circuit board.

24. A multi-function assembly, comprising:
a functional layer comprising one or more multi-function units for reflecting wireless signals;
a blocking layer arranged at a side of the functional layer; and
an antenna assembly arranged at a side of the blocking layer and comprising a non-millimeter wave antenna unit and a millimeter wave antenna unit, the multi-function units being reused as the millimeter wave antenna unit and the multi-function units being reused as a portion of the non-millimeter wave antenna unit.
